(19) United States
(12) Patent Application Publication
(10) Pub. No.: US 2006/0196121 A1
(43) Pub. Date: Sep. 7, 2006

(54) Guide strip for a sliding window or sliding door

(75) Inventor: Frank Xavier Heads, Queensland (AU)

Correspondence Address: STEPTOE & JOHNSON LLP, 1330 CONNECTICUT AVENUE, N.W., WASHINGTON, DC, 20036, US

(73) Assignee: Bradnam' s Window & Doors PTY Ltd., Greenbung (AU)

(21) Appl. No.: 10/568,953

(22) PCT Filed: Sep. 2, 2004
(86) PCT No.: PCT/AU04/01189

§ 371 Date: Feb. 22, 2006

(30) Foreign Application Priority Data
Sep. 9, 2003 (AU) 2003904907

(51) Int. Cl. E05D 15/22; E05F 11/00

(52) U.S. Cl. 49/194; 49/360; 49/361

(57) ABSTRACT

A sliding door or window assembly has at least one sliding door or window, a surround frame having a lower portion containing a vertical wall, and guide strip positionable between the door or window and the vertical wall, the guide strip comprising a continuous length of material, the material comprising a plurality of spaced apart projections, the projections adapted to prevent the door or window from contacting the vertical wall.

### FIELD OF THE INVENTION

This invention is directed to a guide strip that can be fitted to a sliding window, sliding door or other sliding member and which can prevent direct contact or rubbing of the sliding member to an adjacent member. The invention will be described with reference to use with a sliding window or sliding door but no limitation is meant thereby and the invention may also extend to cover any other sliding member.

### BACKGROUND ART

A sliding window or a sliding door has a sliding member sliding within a fixed member. The fixed member is usually the window or door surround frame and the sliding member is usually the sliding door or sliding window. The sliding window or sliding door typically comprises a glass window or a glass door which slides within an aluminium surround frame. Alternatively, the sliding door can comprise a security screen door. The glass window or glass door also contains a metal (typically aluminium) frame around the glass panel. Thus, when the sliding window or sliding door is moved, there is a risk that there will be metal to metal rubbing. This type of rubbing is extremely undesirable as the sliding window or sliding door is usually powder coated and the rubbing can result in removal of the protective coating. This can result in corrosion of the metal especially in hostile environments such as near the coast.

It is known to provide a rubbing strip on a sliding window or sliding door or other type of sliding member to prevent direct metal to metal contact. The rubbing strip typically comprises a plastic or rubber spline which is fitted to the bottom of the door/window or surround frame. A disadvantage with this arrangement is that the contact between the windows/door and the spline can increase the force required to move the window or door because of the friction engagement with the windows/door and the spline. When the door/window is under a wind loading (i.e. a wind is blowing against the window or door) this can result in the windows/door pressing up against the spline which increases the frictional engagement and in some circumstances this can make it extremely difficult to open the window or door.

There are some circumstances where it is also necessary to provide a flow from one side of the sliding member to the other side of the sliding member. With outdoor windows it is known to provide slots in the metal surround frame to remove any pressure differential between the inside of the sliding window and the outside of the sliding window. This prevents water from being sucked from the outside of the window to the inside of the window because of the pressure differential. However, a rubbing strip can reduce the flow of air from one side of the window (or other type of member) to the other side of the window. Therefore, a rubbing strip suffers from some disadvantages.

A partial solution is known where a number of holes are drilled into the bottom of the surround frame and separate clips are inserted into the holes. The clips prevent direct metal to metal rubbing. However, it is extremely tedious to attach an array of such clips, and drilling holes through a powder coated surround frame is undesirable as it can result in a point of corrosion formation.

Therefore, there would be a significant advantage if it were possible to provide a means to prevents metal to metal rubbing (or if the members are not formed of metal, member to member rubbing), and which does not make it difficult to open or close the sliding member specially under high wind load conditions and which can also provide some flow of air if necessary, and which did not require the tedious attachment of a plurality of separate clips.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide a guide strip which may overcome at least some of the above-mentioned disadvantages or provide the public with a useful or commercial choice.

In one form, the invention resides in a guide strip positionable between a fixed member and a sliding member or between a pair of sliding members that move relative to each other, the guide strip comprising a continuous length of material, the material comprising a plurality of spaced apart projections, the projections adapted to prevent the fixed member and the sliding member from contacting each other.

In this manner, a continuous guide strip can be manufactured and typically cut to length and positioned between a sliding window or sliding door and the respective surround frame. By having a plurality of projections which are spaced apart, the two members are held apart but the frictional contact is much less than a continuous strip. Thus, the sliding member can still be moved even under heavy wind loading. Also, the spacing between adjacent projections allows air to flow from below the guide strip to above the guide strip which is something that has been difficult if not impossible with a continuous strip. Another advantage is that the strip can be fixed quickly and easily to present a multiplicity of projections which is an advantage over the conventional arrangement where separate clips need to be pushed into a hole drilled into the surround frame.

The guide strip can be made of any suitable material and this will depend on what members the guide strip will be holding apart, and where the guide strip will be placed. If the guide strip is used with a sliding door or sliding window, one possibility is to manufacture the guide strip from plastics material, composite material such as plastic composite materials, rubbers, rubber composites. As an example, the guide strip could be made from nylon, or other relatively hard and wear resistant engineering materials such as engineering plastics. It would be advantageous if the guide strip or particularly the projections have a low coefficient of friction and this can affect the choice of materials and especially the choice of plastics materials. However, the guide strip may be made of other materials such as metals and it is envisaged that the guide strip may have a metal backing and possibly low friction projections attached to the metal backing. Other arrangements are also envisaged.

The guide strip may be formed in a continuous length and cut to length. Alternatively, the guide strip may be formed in discrete lengths.

The guide strip will typically have a relatively flat back wall to enable it to the fitted to a surround frame or one of the members or any suitable point. However, the guide strip may also have a back wall which is not flat and this may be necessary if the material to which the guide strip is attached is also not flat (for instance is ribbed, profiled or otherwise shaped).

The guide strip can have a variable width depending on where the guide strip will be used. For a sliding window or a sliding door, it is envisaged that the guide strip will have a width of between 5-50 millimetres.

The projections which form part of the guide strip will typically be identical or substantially identical as this will make it easier to manufacture the guide strip. The projections may comprise buttons, ribs, dome like protrusions, rod like protrusions, cubic like protrusions, triangular type protrusions and the like and it is not considered that any limitation should be placed on the shape of the projection. The number of projections on the guide strip can vary depending on where the guide strip will be used. For instance, the projections can be spaced apart by spacing of between 1-100 millimetres although this is an example only. The projections can also extend from the remainder of the guide strip by distance of between 1-10 millimetres although this is an example only.

The guide strip can be fitted to one of the members by any suitable means. However, as it is undesirable to drill holes through a powder coated surround frame, it is preferred that the surround frame is formed with a slot and that the guide strip can be secured in the slot. Thus, the guide strip may be provided with a profile or shape to enable it to pass into the slot while having the projections extending out of the slot. However, other types of attachment are envisaged including the use of adhesive or other means.

### BRIEF DESCRIPTION OF THE DRAWINGS

An embodiment of the invention will be described with reference to the following drawings in which:

FIG. 1. Is a plan section view showing a sliding window in a surround frame and protected against metal to metal rubbing by a guide strip according to an embodiment of the invention.

FIG. 2. Is a view of the guide strip.

### BEST MODE

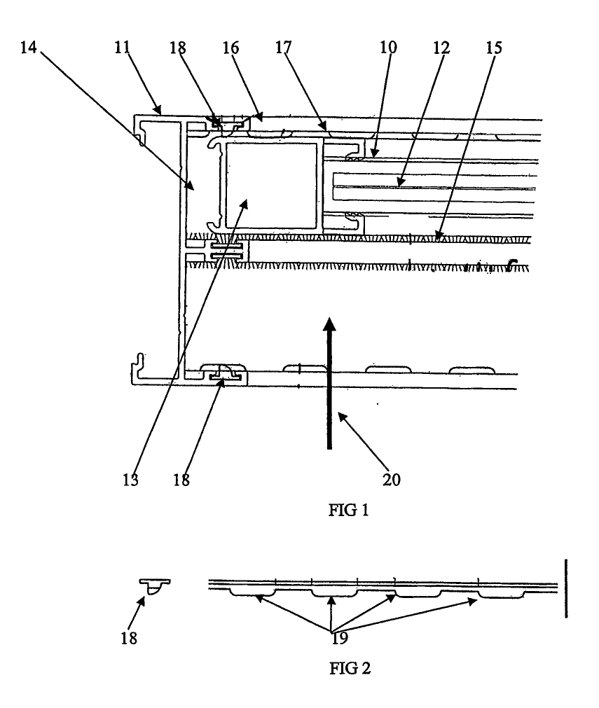

Referring to the drawings and initially to FIG. 1, there is illustrated in plan view a sliding window 10 in a fixed surround frame 11. Sliding window 10 contains a sheet of window glass 12 fixed in a frame 13, the frame typically be made from aluminium. The entire sliding window slides within a channel 14 in surround frame 11. Typically, the sliding window 10 will be provided with rollers (not illustrated) on the bottom of the window to assist in the sliding action. For smaller windows, the window can simply slide on a rail (not illustrated) in the surround frame 11. Typically, the sliding window 10 and the surround frame 11 are both formed of aluminium and the aluminium is typically powder coated, anodised, or otherwise treated. Therefore, to maintain the aesthetic appeal and corrosion resistance of the sliding window and the surround frame, it is necessary to ensure that there is no direct rubbing or contact between the metal part of the sliding window 10 and the metal surround frame 11. Also, it is necessary to ensure that the sliding window can be easily moved between the open position and closed position without excessive frictional resistance.

In FIG. 1, the outside of sliding window 10 contains a strip of bristles 15 which function to prevent dirt and debris from passing into the bottom of the window surround frame 11. This is well-known. The inside of sliding window 10 is prevented from rubbing against and adjacent metal part 16 of surround frame 11 by a guide strip 17 which is better illustrated in FIG. 2. In the particular embodiment, guide strip 17 is formed of a nylon 6.6, acetal, LURAN, or other type of hard material which has a low coefficient of friction relative to the polyester powder coat which protects the metal surface of the surround frame and the window. Guide strip 17 is fixed within a slot or channel (not illustrated) on the metal part 16 to hold the guide strip in position. A small end member 18 is provided which is fixed within a channel on metal part 16 (see FIG. 1) to hold the guide strip 17 within the slot. Of course, other ways of attachment of guide strip 17 may be used.

Guide strip 17 comprises a continuous length of material which is cut to size. The guide strip contains a plurality of spaced apart projections 19 which contact the sliding window 10 to prevent the sliding window from rubbing up against metal part 16. By having a series of projections as opposed to a continuous strip, the frictional engagement is considerably reduced. Furthermore, air can pass between the projections which may be an advantage if pressure equalisation is required in the particular application of the guide strip. Each projection has a length of approximately 11 millimetres and the spacing between projections is approximately 9 millimetres. Each projection extends outwardly by between 1-4 millimetres.

The guide strip finds particular use if there is a heavy wind load on the outside of the window and in the direction of arrow 20 (see FIG. 1). Without the guide strip, a wind load will cause the sliding window to push against and rub against metal part 16. If a continuous strip is placed between the sliding window and the metal part, the wind load can cause increased frictional resistance which may make it difficult or impossible to open or close the window.

The guide strip can be fitted into a continuous strip to provide guidance and consistent spacing for adjacent members. The guide strip can be used to hold sashes with accurate/constant cross-sectional spacing against and adjacent surfaces preventing the surface to surface contact and/or resultant damage. The sliding members can move horizontally or vertically. The guide strip is easily replaceable should this become necessary. The guide strip has been described with reference to its use in a sliding window or sliding door. However, the guide strip can also be used in other applications where two surfaces slide or move relative to each other and where it is desirable to prevent direct contact and also to minimise friction and possibly also to allow pressure equalisation to occur.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

It should be appreciated that various other changes and modifications can be made to any embodiment described without departing from the spirit and scope of the invention.

1. A guide strip positionable between a pair of members that slide relative to each other, the guide strip comprising a continuous length of material, the material comprising a plurality of spaced apart non-bristle projections extending along the guide strip and defining gaps between adjacent projections, the projections adapted to prevent the members from contacting each other, the gaps enabling air to flow through the gaps.

2. The strip of claim 1, wherein at least one said member is a door or window.

3. The strip of claim 2, wherein one member is stationary and the other member slides relative to the one member.

4. The strip of claim 2, wherein both members slide.

5. The strip of claim 2, wherein the strip has a width of between 5-50 mm.

6. The strip of claim 5, wherein the projections are spaced apart by between 1-100 mm.

7. The strip of claim 6, wherein the projections project by a distance of between 1-10 mm.

8. A sliding door or window assembly comprising at least one sliding door or window, a surround frame having a lower portion containing a vertical wall, and guide strip positionable between the door or window and the vertical wall, the guide strip comprising a continuous length of material, the material comprising a plurality of spaced apart non-bristle projections extending along the guide strip and defining gaps between adjacent projections, the projections adapted to prevent the door or window from contacting the vertical wall, the gaps enabling air to flow past the guide strip.

9. The assembly of claim 8, wherein the guide strip is attached to the vertical wall.

10. The assembly of claim 9, wherein the wall contains a slot and the guide strip is attached to the wall via the slot.
